(19) United States
(12) Patent Application Publication
(10) Pub. No.: US 2012/0149216 A1
(43) Pub. Date: Jun. 14, 2012

(54) CONNECTOR FOR CONNECTING SUBSTRATES TO EACH OTHER, AND STRUCTURE FOR CONNECTING SUBSTRATES TO EACH OTHER

(75) Inventor: Tingfei Weng, Osaka (JP)

(73) Assignee: SHARP KABUSHIKI KAISHA, Osaka (JP)

(21) Appl. No.: 13/389,132

(22) PCT Filed: Jun. 8, 2010
(86) PCT No.: PCT/JP2010/059643

§ 371 Date: Feb. 6, 2012

(30) Foreign Application Priority Data
Aug. 21, 2009 (JP) 2009-191648

(51) Int. Cl. H01R 12/59

(52) U.S. Cl. 439/65

(57) ABSTRACT

Provided is a board-to-board connector with which connecting workability can be improved. The board-to-board connector (1) is provided with a first connector (10) mounted on a first board (45A) and a second connector (20) mounted on a second board (45B), the first connector (10) is provided with an inverted L-shaped first electric contact (11) and a first insulating housing (12) which has a substantially rectangular shape and holds the first electric contact (11), the terminal section (11a) of the first electric contact (11) is disposed in a groove section (12b) formed in the upper surface (12a) of the first insulating housing (12), the second connector (20) is provided with an inverted L-shaped second electric contact (21) and a second insulating housing (22) which holds the second electric contact (21) and which is formed with a connector housing section (22a) that is opened so as to be able to house the first connector (10), and the terminal section (21a) of the second electric contact (21) which is to contact the terminal section (11a) of the first electric contact (11) is disposed in a groove section (22d) formed in the undersurface (22c) of an upper wall (22b) of the connector housing section (22a).

### TECHNICAL FIELD

The present invention relates to a board-to-board connector for connecting printed circuit boards to each other and a board-to-board connecting structure.

### BACKGROUND ART

As an example of a flat screen display device, a liquid crystal display device equipped with a transmissive liquid crystal display panel, for instance, is such that a backlight unit is generally disposed on the side of the back surface of the liquid crystal display panel. This backlight unit is a device which includes fluorescent lamps such as cold cathode fluorescent lamps (CCFLs) as the light source and which adjusts the properties of light emitted from these fluorescent lamps and irradiates the back surface side of the liquid crystal display panel with the light. As a result of the irradiated light passing through the liquid crystal display panel, an image is displayed in a visible state on the side of the front surface of this liquid crystal display panel.

FIG. 6 is a diagram schematically showing the structure of a commonly used conventional liquid crystal display device. As is shown in the figure, a liquid crystal display device 31 includes a bezel 32, a liquid crystal display panel 33, and a backlight unit 34. The bezel 32 is a member that constitutes as the frame of the liquid crystal display panel 33 and holds the peripheral edges of the liquid crystal display panel 33. The liquid crystal display panel 33 is formed by pasting two sheets of glass and sealing a liquid crystal therebetween.

The backlight unit 34 is configured of a frame 35, optical sheets 37 through 39, a diffusion plate 40, fluorescent lamps 41, a reflective sheet 42, and a backlight chassis 43. The frame 35 has the shape of a frame and is a member for fixing the optical sheets 37 through 39 and diffusion plate 40 in a laminated state to the backlight chassis 43.

The optical sheets 37 through 39 and diffusion plate 40 are optical members which adjust the properties of the light that is incident on the liquid crystal display panel 33 from the fluorescent lamps 41. By disposing such optical members above the fluorescent lamps 41, the luminance within the light-emitting surface of the backlight unit 34 can be made uniform while preventing the shadow of the fluorescent lamps 41 (lamp image) from appearing in this light-emitting surface. Furthermore, the reflective sheet 42 provided underneath the fluorescent lamps 41 is a member for causing light emitted from the fluorescent lamps 41 to be reflected to the side of the liquid crystal display panel 33.

The backlight chassis 43 is formed into the shape of a shallow box from a plate material made of metal such that a plurality of fluorescent lamps 41 can be housed on the inside thereof. As shown in the figure, the light from the plurality of fluorescent lamps 41 provided in a row inside the backlight chassis 43, together with the light reflected by the reflective sheet 42, is designed to pass through the diffusion plate 40, optical sheets 37 through 39, and liquid crystal display panel 33 so as to be visually recognized on the side of the viewer.

An inverter circuit board 45 composed of a printed circuit board that generates a pulsed high voltage for lighting the fluorescent lamps 41 and a control circuit board 46 similarly composed of a printed circuit board that controls the driving of the liquid crystal display panel 33 are attached to the back surface of the backlight chassis 43. Such an inverter circuit board 45 and control circuit board 46 are designed to be respectively covered by an inverter circuit board cover 47 and a control circuit board cover 48 that are each formed of a plate member made of metal.

As the size of the liquid crystal display panel 33 has increased, the size of such a backlight unit 34 has also been increased in recent years, and the number of the fluorescent lamps 41 housed on the inside has also been increased. With an increase in the number of the fluorescent lamps 41, the size of the inverter circuit board 45 has also been increased, so there are cases in which the inverter circuit board is not configured from a single board and inverter circuit boards 45A and 45B are used, in which the inverter circuit board is divided into a plurality of boards (e.g., two boards).

For the inverter circuit boards 45A and 45B thus divided, a board-to-board connector (so-called B-to-B connector (board-to-board connector)) that electrically connects two boards is normally used in order to exchange electrical signals between the boards (board to board) or to supply power from one board to the other board.

FIG. 7 shows the conventionally used board-to-board connector described in Patent Document 1 below. As shown in FIG. 7(a), a board-to-board connector 50 includes a plug connector (first connector) 60 and a socket connector (second connector) 70.

The plug connector (first connector) 60 is configured of a movable housing 61 having insulating properties, a base housing 62 which is separated from this movable housing 61 and which similarly has insulating properties, and an electric contact 63 attached to the two housings 61 and 62. The male terminal section 63a of the electric contact 63 has a plate shape and is fixed so as to protrude horizontally from the front surface of the flat plate section 61a of the movable housing 61. In this case, a guide pin 61b is formed so as to protrude from the front surface of the flat plate section 61a of the movable housing 61.

Moreover, the board connecting section 63c, which, having a horizontal U-shaped curved section 63b at an intermediate point, hangs straight from the rear end of this male terminal section 63a, is fixed to the base housing 62. The tip end of the board connecting section 63c that protrudes from the bottom surface of the base housing 62 is inserted into a through-hole 45a of one inverter circuit board 45A and electrically connected by soldering to a circuit pattern 45b formed on the back surface of the board 45A. In this case, the inverter board 45A is fixed via a spacer 45c to the back surface of the backlight chassis 43 by means of a screw 45d.

Meanwhile, the socket connector (second connector) 70 which can mate with the plug connector 60 includes a housing 71 having insulating properties and an electric contact 72 which has on the inside of this housing 71 a female terminal section 72a that sandwiches the male terminal section 63a of the electric contact 63 of the plug connector 60 and makes electrical connection therewith. The tip end of the board connecting section 72b of the electric contact 72 that protrudes from the bottom surface of the housing 71 is inserted into a through-hole 45a of the other inverter circuit board 45B and electrically connected by soldering to a circuit pattern 45b formed on the back surface of the board 45B.

In addition, a pin insertion hole 71a that opens upward is formed in the housing 71 such that the guide pin 61b provided on the movable housing 61 of the plug connector 60 is inserted therein and latches therewith. In this case, the inverter circuit board 45B is fixed via a spacer 45c to the back surface of the backlight chassis 43 by means of a screw 45d.

When such a plug connector 60 and socket connector 70 are to be electrically connected, the movable housing 61 in an upright state is brought down toward the inverter circuit board 45B, which causes the vicinity of the curved section 63b of the electric contact 63 to be bent, and the male terminal section 63a is inserted into the female terminal section 72a as shown in FIG. 7(b), thereby electrical connection is established between the inverter circuit boards 45A and 45B.

Then, attaching the inverter circuit board cover 47 so as to cover the inverter circuit boards 45A and 45B completes the attachment of the inverter circuit boards 45A and 45B to the back surface of the backlight chassis 43.

### Related Art Documents

### Patent Documents

Patent Document 1: Japanese Utility Model Application Laid-Open Publication No. H3-84572

### SUMMARY OF THE INVENTION

### Problems to be Solved by the Invention

However, the protruding male terminal section 63a of the plug connector 60 is easily bent when inserted into and removed from the female terminal section 72a of the socket connector 70, so there are cases in which the male terminal section 63a of the plug connector 60 is not inserted into a specified position of the female terminal section 72a of the socket connector 70, resulting in failure to connect the two terminal sections 63a and 72a in an electrically conductive manner. In addition, there is a problem in that an uncovered portion such as the curved section 63b of the electric contact 63 of the plug connector 60 ends up touching the inverter circuit board cover 47.

Thus, in cases where the two terminal sections 63a and 72a are not connected in an electrically conductive manner, or in cases where the electric contact 63 and the inverter circuit board cover 47 made of metal come into contact, transfer of power or electrical signals between the inverter circuit boards 45A and 45B cannot be performed, so the fluorescent lamps 41 cannot be lit. In such cases, it is necessary to perform repair by removing the inverter circuit board cover 47, which is cumbersome, thus creating a problem.

Furthermore, the guide pin 61b provided on the movable housing 61 of the plug connector 60 is prone to getting broken during insertion and removal, and the broken portion ends up remaining in the pin insertion hole 71a in some cases, resulting in the problem of poor workability of connecting between the socket connector 60 and the plug connector 70.

In light of these circumstances, an object of the present invention is to provide a board-to-board connector and a board-to board connecting structure with which connecting workability can be improved.

### Means for Solving the Problems

In order to solve the aforementioned problems, the present invention provides a board-to-board connector for connecting substrates to each other, including a first connector mounted on an end of a first board in parallel to the first board and a second connector mounted on an end of a second board in parallel to the second board, the first connector including a first electric contact having an inverted L shape in one side surface thereof, and a first insulating housing that holds the first electric contact and that has a substantially rectangular shape in one side surface thereof, a terminal section of the first electric contact is disposed in a groove section formed in an upper surface of the first insulating housing, the second connector including a second electric contact that has an inverted L shape in one side surface thereof, and a second insulating housing that holds the second electric contact and that is formed with a connector housing section that is opened so as to be able to house the first connector, and a terminal section of the second electric contact which is to contact the terminal section of the first electric contact is disposed in a groove section formed in the undersurface of an upper wall of the connector housing section.

Moreover, in order to solve the aforementioned problems, the present invention provides a board-to-board connecting structure, including a first connector mounted on an end of a first board in parallel to the first board while also provided with a second connector mounted on an end of a second board in parallel to the second board, and which is constituted such that the second board is connected to the first board by connecting the first connector to the second connector, wherein the first connector includes a first electric contact having an inverted L shape in one side surface thereof, and a first insulating housing that holds the first electric contact and that has a substantially rectangular shape in one side surface thereof, a terminal section of the first electric contact is disposed in a groove section formed in an upper surface of the first insulating housing, the second connector includes a second electric contact that has an inverted L shape in one side surface thereof, and a second insulating housing that holds the second electric contact and that is formed with a connector housing section that is opened so as to be able to house the first connector, and a terminal section of the second electric contact which is to contact the terminal section of the first electric contact is disposed in a groove section formed in an undersurface of an upper wall of the connector housing section.

In this case, in such a board-to-board connector and board-to-board connecting structure, it is preferable to adopt a configuration in which a protruding section is formed on the upper surface of the first insulating housing, while a recessed section with which this protruding section engages is formed in the connector housing section of the second insulating housing.

In addition, it is preferable to adopt a configuration in which one of the terminal section of the first electric contact and the terminal section of the second electric contact is formed with a curved section that elastically contacts the other or a configuration in which both the terminal section of the first electric contact and the terminal section of the second electric contact are respectively formed with curved sections that elastically contact each other.

### Effects of the Invention

With the board-to-board connector and the board-to-board connecting structure according to the present invention having the aforementioned configurations, the first connector includes a first electric contact having an inverted L shape in one side surface thereof, and a first insulating housing that holds the first electric contact and that has a substantially rectangular shape in one side surface thereof, a terminal section of the first electric contact is disposed in a groove section formed in the upper surface of the first insulating housing, the second connector includes a second electric contact that has an inverted L shape in one side surface thereof, and a second insulating housing that holds the second electric contact and that is formed with a connector housing section that is opened so as to be able to house the first connector, and the terminal section of the second electric contact which is to contact the first electric contact is disposed in a groove section formed in an undersurface of an upper wall of the connector housing section. Consequently, merely by housing the first connector in the connector housing section of the second connector, the respective electric contacts are connected to each other in an electrically conductive manner, so the connecting workability is improved. Furthermore, when the first connector and the second connector are connected, the electric contacts provided in the two connectors are not exposed.

Accordingly, even if a member made of metal such as an inverter circuit board cover, for example, is disposed above the board-to-board connector, there is no risk of this member and the electric contacts of the board-to-board connector coming into contact. Moreover, the first board on which the first connector is mounted and the second board on which the second connector is mounted are normally positioned on the mounting surface of a case such as the backlight chassis and fixed thereto, so this is also designed to prevent the worker from forgetting to connect between the first connector and the second connector. That is, unless the first connector and the second connector are placed in a connected state, positioning and fixing cannot be performed on the mounting surface of the case, which makes it possible to securely prevent the worker from forgetting to connect between the first connector and the second connector.

If a protruding section is formed on the upper surface of the first insulating housing, while a recessed section with which this protruding section engages is formed in the connector housing section of the second insulating housing, then positioning at the time of connection between the first connector and the second connector is facilitated, and it is also possible to prevent the aforementioned problem that the guide pin 61b of the plug connector 60 gets broken off and ends up remaining in the pin insertion hole 71a of the socket connector 70.

Moreover, if either the terminal section of the first electric contact or the terminal section of the second electric contact is formed with a curved section that elastically contacts the other or if both the terminal section of the first electric contact and the terminal section of the second electric contact are respectively formed with curved sections that elastically contact each other, the first electric contact of the first connector and the second electric contact of the second connector can be securely connected in an electrically conductive manner, thus improving the connecting reliability of the board-to-board connector.

### BRIEF DESCRIPTION OF THE DRAWINGS

FIG. 1 is a sectional view showing a schematic configuration of a board-to-board connector according to one embodiment of the present invention.

FIG. 2(a) is a sectional view showing a schematic configuration of a first connector provided in the board-to-board connector of FIG. 1, and FIG. 2(b) is a sectional view showing a schematic configuration of a second connector provided in the board-to-board connector of FIG. 1.

FIG. 3 is an external perspective view of the first connector provided in the board-to-board connector of FIG. 1 as viewed from the rear.

FIG. 4 is an external perspective view of the second connector provided in the board-to-board connector of FIG. 1 as viewed from the front.

FIG. 5 is a sectional view showing a state in which inverter circuit boards connected by the board-to-board connector of FIG. 1 are attached to a backlight chassis.

FIG. 6 is an exploded perspective view showing a schematic configuration of a conventionally used liquid crystal display device.

FIG. 7(a) is a sectional view showing a state prior to the connection with a conventionally used board-to-board connector, and FIG. 7(b) is a sectional view showing a state following the connection.

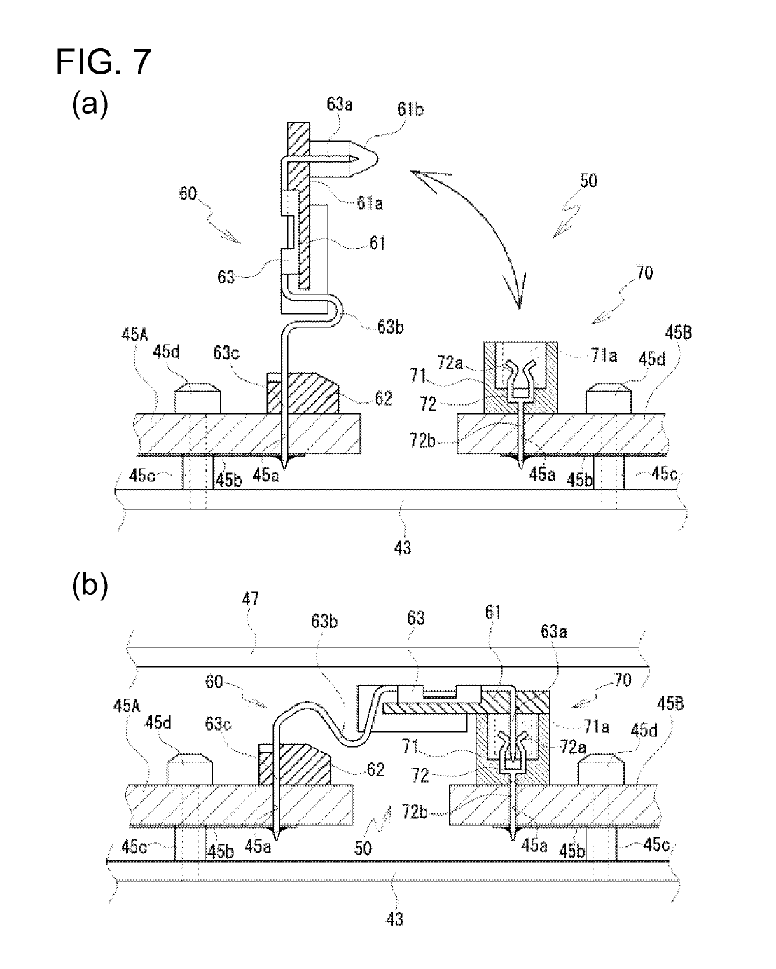

### DETAILED DESCRIPTION OF EMBODIMENTS

Embodiments of the board-to-board connector and the board-to-board connecting structure of the present invention will be described in detail below with reference to the figures. Note that in the following embodiments, a description will be given with the side of a first connector to be connected to a second connector (mating side) being taken as the front, and the side of the second connector to be connected to the first connector (mating side) similarly being taken as the front.

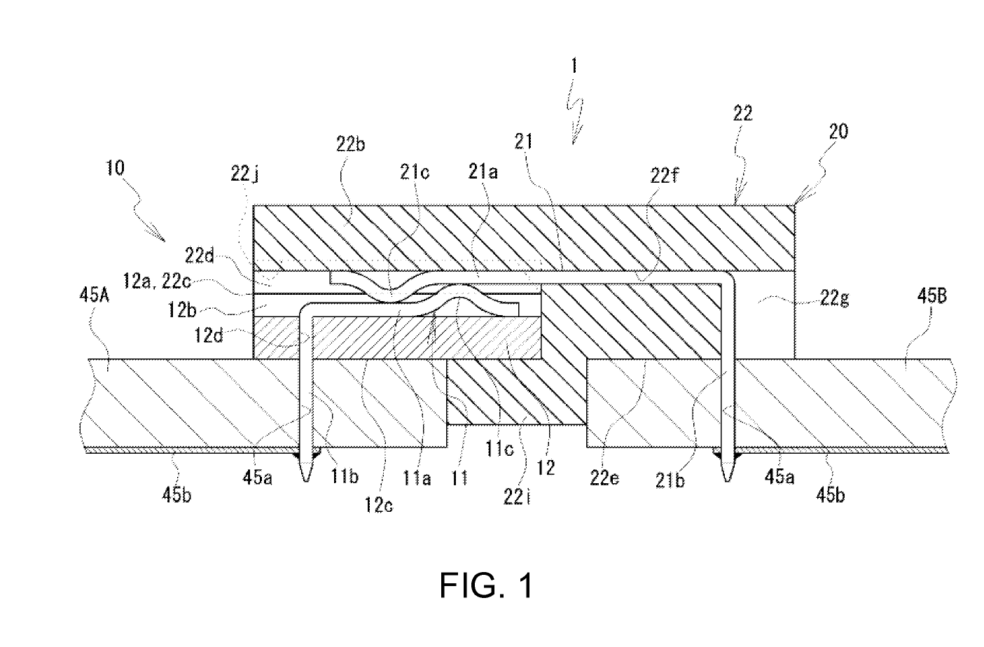

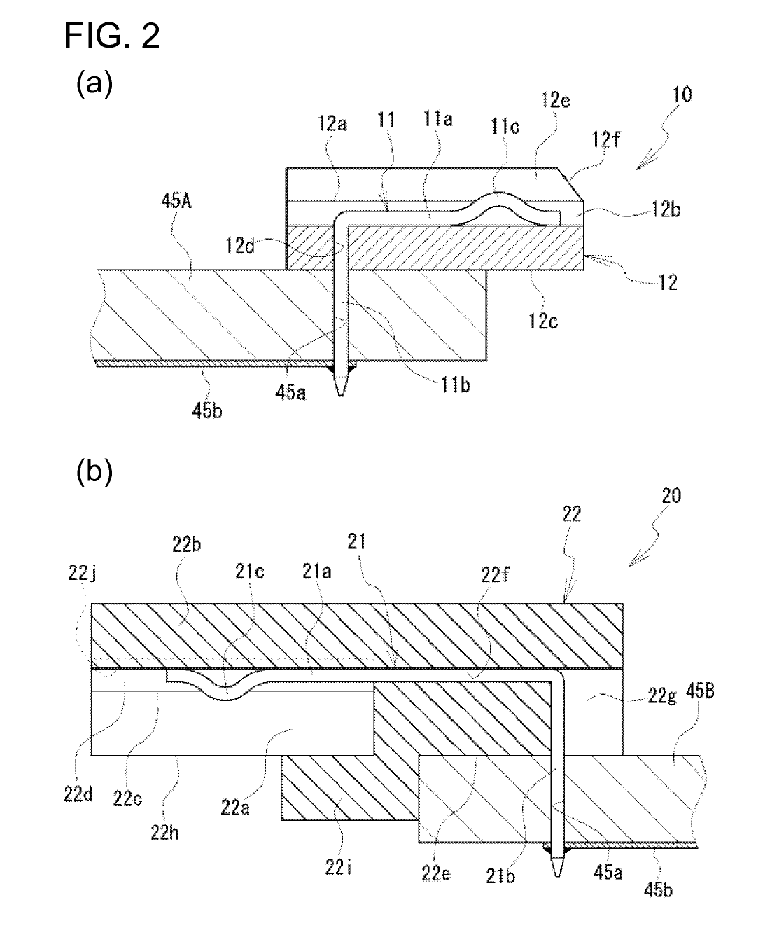

As shown in FIGS. 1, 2(a), and 2(b), a board-to-board connector 1 includes a first connector 10 mounted on the upper surface of an end of an inverter circuit board (first board or substrate) 45A in parallel to this inverter circuit board 45A and a second connector 20 mounted on the upper surface of an end of an inverter circuit board (second board or substrate) 45B in parallel to this inverter circuit board 45B.

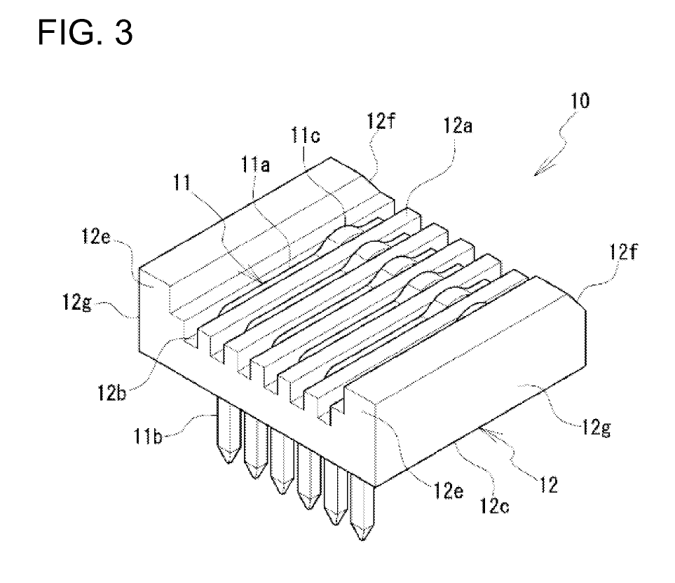

As shown in FIGS. 2(a) and 3, the first connector 10 includes first electric contacts 11 one side surface of each of which has an inverted L shape and a first insulating housing 12 which holds the first electric contacts 11 and one side surface of which has a substantially rectangular shape.

Each of the first electric contacts 11 is formed into an inverted L shape by stamping, bending, and the like of a plate member made of metal and has a terminal section 11a that extends forward and a board connecting section 11b that hangs downward from the rear end of this terminal section 11a.

The terminal sections 11a of the first electric contacts 11 are designed to be connected to second electric contacts 21 of the second connector 20 which will be described later, and in this case, these terminal sections 11a are respectively disposed in a plurality of groove sections 12b which are provided so as to extend forward and rearward in the upper surface 12a of the first insulating housing 12. Furthermore, curved sections 11c that are curved so as to protrude from the upper surface 12a are respectively formed at an intermediate point toward the front of the terminal sections 11a. In this case, as shown in FIG. 1, the curved sections 11c protrude a specified length from the upper surface 12a of the first insulating housing 12 so as to be able to elastically contact the terminal sections 21a of the second electric contacts 21 within groove sections 22d of the second connector 20.

The tip ends of the board connecting sections 11b that protrude downward from the bottom surface 12c of the first insulating housing 12 mounted on the upper surface of an end of the inverter circuit board 45A are respectively inserted into through-holes 45a of the inverter circuit board 45A and electrically connected by soldering to a circuit pattern 45b formed on the back surface of the board 45A.

In this case, as a result of the board connecting sections 11b being respectively press-fitted into insertion holes 12d that are respectively formed so as to pass through vertically the first insulting housing 12 at a rear point of the groove sections 12b, the first electric contacts 11 are designed to be held in the first insulating housing 12. Moreover, protruding sections 12e, 12e that extend forward and rearward are provided on both the left and right sides of the upper surface 12a of the first insulating housing 12. Tapered surfaces 12f that are inclined downward toward the front are formed on the front end surfaces of these protruding sections 12e, and these tapered surfaces 12f are designed to facilitate fitting (insertion) into recessed sections 22j of the connector housing section 22a of the second connector 20 which will be described later.

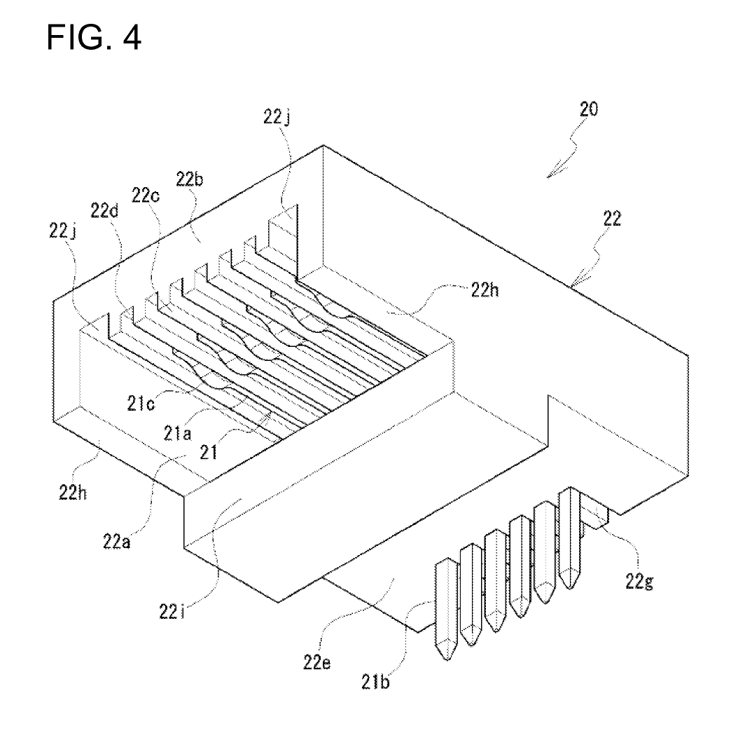

As shown in FIGS. 2(b) and 4, the second connector 20 includes second electric contacts 21 one side surface of each of which has an inverted L shape and a second insulating housing 22 which holds these second electric contacts 21.

Each of the second electric contacts 21 is formed into an inverted L shape by stamping, bending, and the like of a plate member made of metal and has a terminal section 21a that extends forward and a board connecting section 21b that hangs downward from the rear end of this terminal section 21a.

The terminal sections 21a of the second electric contacts 21 are designed to be connected to the first electric contacts 11 of the aforementioned first connector 10, and in this case, these terminal sections 21a are respectively disposed in a plurality of groove sections 22d that are provided so as to extend forward and rearward in the undersurface 22c of an upper wall 22b of the connector housing section 22a of the second insulating housing 22. Furthermore, curved sections 21c that are curved so as to protrude from the undersurface 22c are respectively formed at an intermediate point toward the front of the terminal sections 21a. In this case, as shown in FIG. 1, the curved sections 21c protrude a specified length from the undersurface 22c of the upper wall 22b so as to be able to elastically contact the terminal sections 11a of the first electric contacts 11 within the groove sections 12b of the first connector 10.

The tip ends of the board connecting sections 21b that protrude downward from the bottom surface 22e of the second insulating housing 22 mounted on the upper surface of an end of the inverter circuit board 45B are respectively inserted into through-holes 45a of the inverter circuit board 45B and electrically connected by soldering to a circuit pattern 45b formed on the back surface of the board 45B.

In the second insulating housing 22, insertion holes 22f that communicate with the groove sections 22d thereof are formed so as to pass through horizontally, and insertion spaces 22g that communicate with these insertion holes 22f and have the shape of slits open vertically in the second insulating housing 22. In this case, the second electric contacts 21 are designed to be held in the second insulating housing 22 as a result of the terminal sections 21a thereof being respectively press-fitted into the insertion holes 22f via the insertion spaces 22g, which causes the board connecting sections 21b to be housed in a position further toward the interior of the insertion spaces 22g.

The connector housing section 22a of the second insulating housing 22 is designed to be able to house the first connector 10 (first insulating housing 12) and is configured of the upper wall 22b having the groove sections 22d formed in the undersurface 22c, side walls 22h, 22h that extend downward from both the left and right sides of this upper wall 22b, and a lower wall 22i that is provided so as to extend forward from the bottom surface 22e.

In this case, as shown in FIGS. 1 and 2, the lengths of the upper wall 22b and side walls 22h, 22h in the forward-rearward direction are set at lengths that can cover both the left and right side surfaces and the upper surface of the first connector 10 (i.e., both the left and right side surfaces 12g, 12g and the upper surface 12a) of the first insulating housing 12 at the time of the connection with this first connector 10. In addition, the lower end position of the side walls 22h, 22h and the front end position of the lower wall 22i are set such that there is no interference with the end of the inverter board 45A at the time of the connection with this first connector 10 as shown in FIG. 1.

Furthermore, recessed sections 22j, 22j into which the protruding sections 12e, 12e provided on the upper surface 12a of the first insulating housing 12 are fitted (inserted) are provided in the undersurface 22c of the upper wall 22b on both the left and right sides thereof with the recesses oriented upward.

The procedure for attaching the inverter circuit board 45A on which such a first connector 10 is mounted and the inverter circuit board 45B on which the second connector 20 is mounted to the back surface of the backlight chassis 43 will be described. First, when the insertion of the front end of the first insulating housing 12 of the first connector 10 into the opening of the connector housing section 22a of the second insulating housing 22 of the second connector 20 begins, the tapered surfaces 12f of the protruding sections 12e of the first insulating housing 12 are positioned toward the open ends of the recessed sections 22j of the connector housing section 22a of the second insulating housing 22 and guided to the interior thereof.

Next, the curved sections 11c of the first electric contacts 11 and the curved sections 21c of the second electric contacts 21 begin to come into contact, and when the insertion is performed into the position where these sections ride over each other, the front end surface of the first insulating housing 12 contacts the rear surface of the connector housing section 22a of the second insulating housing 22 and is stopped; thereby the connection between the first connector 10 and the second connector 20 is complete (see FIG. 1).

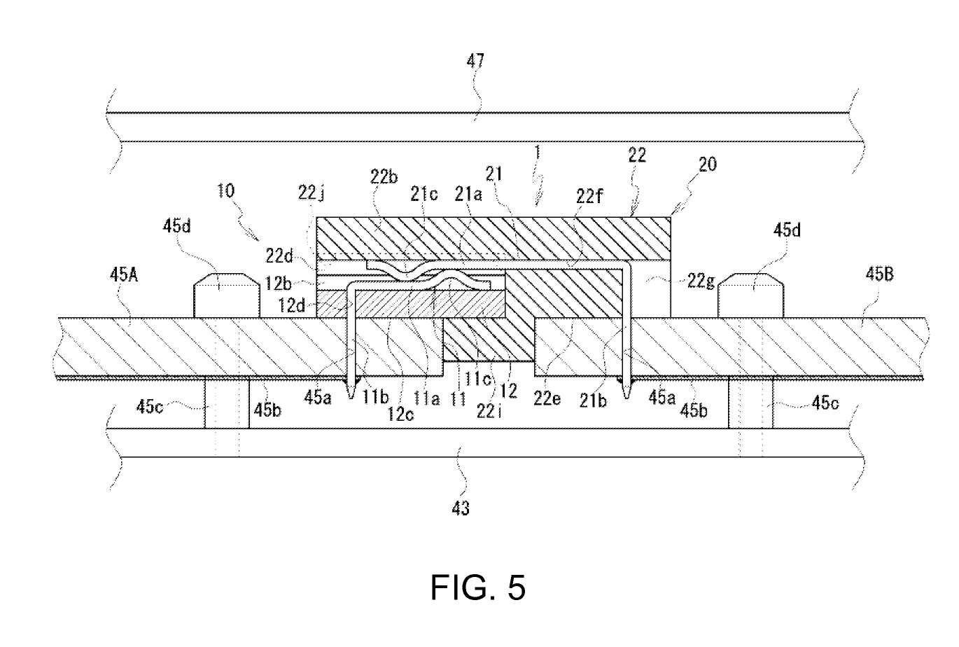

Next, as shown in FIG. 5, with this state left as it is, the inverter board 45A is fixed via a spacer 45c to the back surface of the backlight chassis 43 by means of a screw 45d, and the inverter circuit board 45B is fixed via a spacer 45c to the back surface of the backlight chassis 43 by means of a screw 45d.

Furthermore, by attaching an inverter circuit board cover 47 so as to cover the inverter circuit boards 45A and 45B, the attachment of the inverter circuit boards 45A and 45B to the back surface of the backlight chassis 43 is complete.

In the board-to-board connector 1 described above, the first connector 10 includes first electric contacts 11 one side surface of each of which has an inverted L shape and a first insulating housing 12 which holds the first electric contacts 11 and which has a substantially rectangular shape in its side surfaces, the terminal sections 11a of the first electric contacts 11 are disposed in the groove sections 12b formed in the upper surface 12a of the first insulating housing 12, the second connector 20 includes second electric contacts 21 one side surface of each of which has an inverted L shape and a second insulating housing 22 which holds the second electric contacts 21 and which is formed with a connector housing section 22a that opens so as to be able to house the first connector 10 (first insulating housing 12), and the terminal sections 21a of the second electric contacts 21 that are caused to contact the terminal sections 11a of the first electric contacts 11 are disposed in the groove sections 22d formed in the undersurface 22c of the upper wall 22b of the connector housing section 22a.

As a result of the board-to-board connector 1 having such a configuration, the respective terminal sections 11a and 21a of the electric contacts 11 and 21 are mutually connected in an electrically conductive manner by merely housing the first connector 10 in the connector housing section 22a of the second connector 20, so the connecting workability is improved; furthermore, in a state in which the first connector 10 and the second connector 20 are connected, the electric contacts 11 and 21 provided in the two connectors 10 and 20 are not exposed.

Accordingly, even if a member made of metal such as the inverter circuit board cover 47, for example, is disposed above the board-to-board connector 1, there is no risk of this member touching the electric contacts 11 and 21 of the board-to-board connector 1. Moreover, ordinarily, the inverter circuit board (first board) 45A on which the first connector 10 is mounted and the inverter circuit board (second board) 45B on which the second connector 20 is mounted are positioned on the mounting surface of a case such as the backlight chassis 43 and fixed thereto, so this is designed to prevent the worker from forgetting to connect the first connector 10 and the second connector 20. Specifically, this connector 1 is designed such that it is impossible to perform positioning on and fixing to the mounting surface of the case unless the first connector 10 and the second connector 20 are placed in a connected state, which makes it possible to reliably prevent the worker from forgetting to connect between the first connector 10 and the second connector 20.

In this case, the protruding sections 12e are formed on the upper surface 12a of the first insulating housing 12, and the recessed sections 22j with which these protruding sections 12e engage are formed in the connector housing section 22a of the second insulating housing 22. Therefore, it is easy to perform positioning when the first connector 10 and the second connector 20 are to be connected, and this configuration also prevents the problem described in the prior art which is such that the guide pin 61b of the plug connector 60 is broken off and ends up remaining in the pin insertion hole 71a of the socket connector 70.

In addition, by using a configuration in which either the terminal sections 11a of the first electric contacts 11 or the terminal sections 21a of the second electric contacts 21 are formed with the curved sections 11c (21c) that elastically contact the other or a configuration in which both the terminal sections 11a of the first electric contacts 11 and the terminal sections 21a of the second electric contacts 21 are respectively formed with the curved sections 11c and 21c that elastically contact each other, the first electric contacts 11 of the first connector 10 and the second electric contacts 21 of the second connector 20 can be securely connected in an electrically conductive manner, thus improving the connecting reliability of the board-to-board connector 1.

Thus far, a description has been given regarding an embodiment of the board-to-board connector and the board-to-board connecting structure according to the present invention. However, the present invention is in no way limited to such an embodiment and can readily be carried out in various embodiments within the scope that does not depart from the spirit of the present invention.

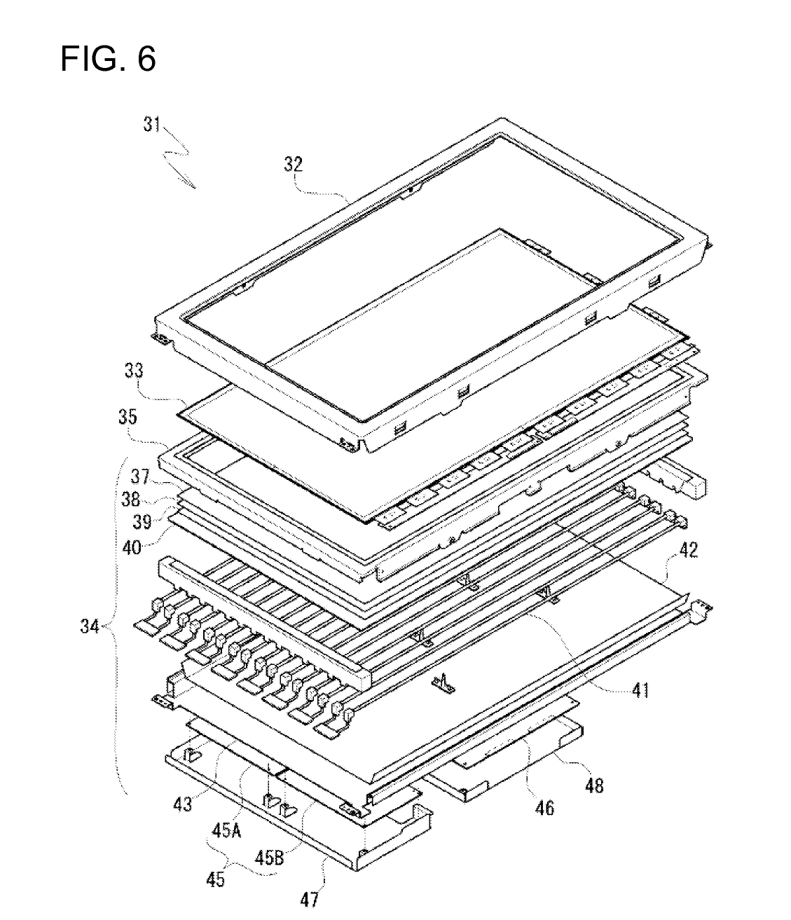

For instance, a description was given regarding a configuration in which the aforementioned board-to-board connector 1 is used to connect between the inverter circuit boards 45A and 45B included in the backlight unit 34 shown in FIG. 6, but this connector can be applied to the connection between printed circuit boards provided in common electrical devices, so the present invention is not limited to the aforementioned embodiment.

1. A board-to-board connector comprising a first connector mounted on an end of a first board in parallel to the first board and a second connector mounted on an end of a second board in parallel to the second board, said first connector comprising a first electric contact having an inverted L shape in one side surface thereof, and a first insulating housing that holds said first electric contact and that has a substantially rectangular shape in one side surface thereof, a terminal section of said first electric contact is disposed in a groove section formed in an upper surface of said first insulating housing, said second connector comprising a second electric contact having an inverted L shape in one side surface thereof, and a second insulating housing that holds said second electric contact and that is formed with a connector housing section that is opened so as to be able to house said first connector, and a terminal section of said second electric contact which is to contact the terminal section of said first electric contact is disposed in a groove section formed in an undersurface of an upper wall of said connector housing section.

2. The board-to-board connector according to claim 1, wherein a protruding section is formed on the upper surface of said first insulating housing, and a recessed section with which said protruding section engages is formed in said connector housing section of said second insulating housing.

3. The board-to-board connector according to claim 1, wherein one of the terminal section of said first electric contact and the terminal section of said second electric contact is formed with a curved section that elastically contacts the other.

4. The board-to-board connector according to claim 1, wherein both the terminal section of said first electric contact and the terminal section of said second electric contact are respectively formed with curved sections that elastically contact each other.

5. A board-to-board connecting structure comprising a first connector mounted on an end of a first board in parallel to the first board, and a second connector mounted on an end of a second board in parallel to the second board, wherein said second board is connected to said first board by connecting said first connector to said second connector, wherein said first connector comprises a first electric contact having an inverted L shape in one side surface thereof, and a first insulating housing that holds said first electric contact and that has a substantially rectangular shape in one side surface thereof, a terminal section of said first electric contact being disposed in a groove section formed in an upper surface of said first insulating housing, said second connector comprising a second electric contact having an inverted L shape in one side surface thereof, and a second insulating housing that holds said second electric contact and that is formed with a connector housing section that is opened so as to be able to house said first connector, wherein a terminal section of said second electric contact which is to contact the terminal section of said first electric contact is disposed in a groove section formed in an undersurface of an upper wall of said connector housing section.

6. The board-to-board connecting structure according to claim 5, wherein a protruding section is formed on the upper surface of said first insulating housing, and a recessed section with which this protruding section engages is formed in said connector housing section of said second insulating housing.

7. The board-to-board connecting structure according to claim 5, wherein one of the terminal section of said first electric contact and the terminal section of said second electric contact is formed with a curved section that elastically contacts the other.

8. The board-to-board connecting structure according to claim 5, wherein both the terminal section of said first electric contact and the terminal section of said second electric contact are respectively formed with curved sections that elastically contact each other.
